(19) United States
(12) Patent Application Publication
(10) Pub. No.: US 2014/0129198 A1
(43) Pub. Date: May 8, 2014

(54) DEVELOPMENT OF WATERSHED FLOW AND ALLOCATION MODEL

(71) Applicant: Research Triangle Institute, Inc., Research Triangle Park, NC (US)

(72) Inventors: Michele Cutrofello Eddy, Durham, NC (US); James Illiad Rineer, Raleigh, NC (US); Brandon Louis Bergenroth, Durham, NC (US); Robert Madison Dykes, Durham, NC (US); Fekadu Game Moreda, Morrisville, NC (US)

(73) Assignee: Research Triangle Institute, Inc., Research Triangle Park, NC (US)

(21) Appl. No.: 14/075,883

(22) Filed: Nov. 8, 2013

Related U.S. Application Data
(60) Provisional application No. 61/724,045, filed on Nov. 8, 2012.

(51) Int. Cl. G06F 17/50

(52) U.S. Cl. CPC G06F 17/5009
USPC 703/9

(57) ABSTRACT

Computer-implemented methods and non-transitory computer readable storage media facilitate calculating outflow of water from a selected catchment. A computer-implemented method calculates an outflow of water from a selected catchment is calculated. An identification of a selected catchment from a plurality of catchments within a geographical area is received from a user workstation. A database of multilayered data is accessed, where the data includes hydrological data, geophysical data, and meteorological data for each of the plurality of catchments within the geographical area. From the multilayered data, one or more additional catchments are automatically identified within the plurality of catchments, to identify a group of navigated catchments that drain into the selected catchment. For a given time period, a model is generated determining an outflow of water from the selected catchment and the group of navigated catchments.

This application claims the benefit of priority of U.S. provisional patent application No. 61/724,045 titled “DEVELOPMENT OF WATERSHED FLOW AND ALLOCATION MODEL,” filed on Nov. 8, 2012, which is incorporated herein in its entirety by this reference.

### FIELD OF THE INVENTION

The present invention relates to compute-implemented methods and computer-readable media for performing watershed analysis.

### BACKGROUND

Although water was once regarded as an abundant or infinite resource, humankind has come to realize that water is a finite and precious resource. For example, the Government Accounting Office of the U.S. Government has reported that 46 states expect to face at least periodic shortages of water during the next ten years. Researchers believe that dramatic fluctuations in local or regional water supplies will become more widespread as a consequence of global climate change. In a world of growing population, where many streams and rivers have grown polluted, fresh water becomes increasingly more precious both as a result of increasing demand and decreasing supply. Large consumers of fresh water, such as public water utilities, agricultural industries, and electric power utilities, are acutely aware of the scarcity of water and are continually looking for new and additional sources of water to satisfy increasing demand.

Further, humankind has come to realize that fresh water is also a fragile resource that is easily laid to waste not only by pollution and mistreatment of water sources themselves, but also by shortsighted or imprudent use of the land over and through which waters flow. Careful land use planning should be increasingly circumspect. For example, before razing a wooded area to construct a large mixed use business and residential complex, one should not only consider how much water such a development would consume, but also should consider the effect building the complex will have on downstream streamflows. In addition to the complex's consumption of water, the deforestation and paving of a large land area may also impair downstream water quality by virtue its very presence.

The U.S. Geological Survey has recently called for an accelerated program for assessing interactions between surface streamflows and groundwater supplies. Other governmental and industrial organizations recognize the need to study water availability and the effect of human activities on the availability of water.

While there are vast stores of hydrological data and geophysical data from which to draw, water availability analysis still presents a daunting challenge. A single parcel of land may be part of a catchment into which water drains from one or more other catchments. The data representing precipitation and other climactic elements across those catchments may be vast and continually shifting as the result of the seasons. The data regarding each of the catchments themselves, in describing how the land is used or what type of soil or other surface covering exists, may be large and varied. Assembling a model to calculate flows generated in a watershed and the changes that may result from climactic or land use changes present a daunting task for a single region of interest, let alone the virtually countless other regions of interest within a single state or province, let alone for the regions across a country.

Thus, it would be desirable to provide methods of correlating disparate sources of data that are used to define land use and climate, calculating streamflows at any point and time as a result of accumulation of streamflows across numerous parcels of land, and providing for manipulation of data that would enable what-if type analysis of the resulting streamflow based on changes in climate or land use.

### SUMMARY

The present disclosure relates to computer-implemented methods and non-transitory computer readable storage media to facilitate calculating outflow of water from a selected catchment which represents the geophysically-defined drainage area comprised of various parcels of land. Hydrological data, meteorological data, and geophysical data are combined into multilayered data to facilitate automated watershed analysis. By identifying for a selected catchment which catchments drain into said catchment, and by determining a volume of water generated in and exiting each of the upstream catchments with an associated lag time for said volumes to reach the selected catchment, an outflow of water from the selected catchment is determined. Using the model, precipitation and temperature, land use changes, or other similar parameter inputs may be manipulated to determine an effect the changes have on the outflow.

According to an embodiment of the present disclosure, computer-implemented methods are disclosed to facilitate calculating outflow of water from a selected catchment by calculating and routing the outflows from each of the catchments upstream of the selected catchment. In a particular embodiment, a computer-implemented method of calculating an outflow of water from a selected catchment is performed at a server computer. An identification of a selected catchment from a plurality of catchments within a geographical area is received from a user workstation. A database of multilayered data is accessed, where the data includes hydrological data, geophysical data, and meteorological data for each of the plurality of catchments within the geographical area. From the multilayered data, a group of navigated catchments including one or more catchments that drain into the selected catchment are automatically identified from the plurality of catchments represented in the multilayered data. For a given time period, a model is generated that determines an outflow of water from the each of the navigated catchments of the group, resulting in a determination of an outflow of water for the selected catchment.

According to another embodiment of the present disclosure, non-transitory computer-readable storage media are described that store instructions executable by a computer system are disclosed to generate multilayered data usable in calculating an outflow of water from a selected catchment. A database of vectorized polygon data (e.g., catchment data, hydrological data, and soils and other surface type data, etc.) is accessed for each of the plurality of catchments within the geographical area. A database of rasterized data (e.g., meteorological data, land use data, etc.) is accessed for each of a plurality of catchments within a geographical area. Multilayered data is generated by correlating data representing each of the plurality of catchments in the vectorized polygon data with the rasterized data corresponding to each of the plurality of catchments.

According to still another embodiment of the present disclosure, non-transitory computer-readable storage media are described that store instructions executable by a computer system to calculate an outflow from a selected catchment into which a plurality of other catchments drain. A database of multilayered data including vectorized polygon data correlated with rasterized data is accessed for each for each of a plurality of catchments within the geographical area. The multilayered data includes, for each of the plurality of catchments, hydrologic data including a stream segment length and an average velocity of water within the stream segment. For a group of navigated catchments including one or more catchments that drain into a selected catchment, based on the multilayered data and the hydrologic data, determine a flow volume from each of the catchments in the group of navigated catchments through the continuous, daily calculation of rainfall runoff, a function of surface conditions and meteorological data, and groundwater flow, a function of subsurface conditions and antecedent moisture, using values contained in or calculated from the multilayered data. An outflow of the selected catchment is determined as a sum of the flow volume from each of the catchments in the group of navigated catchments.

According to one or more embodiments, a computer-implemented method of calculating an outflow of water from a selected catchment is provided. The computer-implemented method includes, at a server computer: receiving from a user workstation an identification of a selected catchment from a plurality of catchments within a geographical area; accessing a database of multilayered data for each of the plurality of catchments within the geographical area; automatically selecting a group of navigated catchments including one or more additional catchments that drain into the selected catchment from the plurality of catchments represented in the multilayered data; and generating a model determining an outflow of water from each of the group of navigated catchments resulting in a determination of an outflow of water from the selected catchment for a given time period.

According to one or more embodiments, the multilayered data includes at least two of hydrological data, geophysical data, and meteorological data.

According to one or more embodiments, the multilayered data includes data for each of the plurality of catchments including at least one of precipitation data; temperature data; land use data; and soil and other surface type data.

According to one or more embodiments, data within the multilayered data is extracted from publicly-available data sources.

According to one or more embodiments, the hydrological data, the geophysical data, and the soil and other surface type data includes vectorized polygon data. Each of a plurality of vectorized polygons represents one of a catchment and another land area that includes one or more catchments.

According to one or more embodiments, the meteorological data and the land use data include rasterized data. Each of the meteorological data and the land use data are associated with a rasterized location within the raster data.

According to one or more embodiments, the method further includes generating the multilayered data by correlating data representing each of the plurality of catchments in the rasterized data and data representing each of the plurality of catchments in the vectorized polygon data.

According to one or more embodiments, correlating the data representing each of the plurality of catchments in the vectorized polygon data and the data representing each of the plurality of catchments in the rasterized data includes automatically correlating the data representing each of the plurality of catchments within the geographical area represented by vectorized polygons in the vectorized polygon data and the data representing each of the plurality of catchments within the geographical area represented by rasterized data.

According to one or more embodiments, the method includes coordinating the multilayered data representing each of the plurality of catchments in the rasterized data and the data representing each of the plurality of catchments in the vectorized polygon data with geographic information system data visually representing the geographical area.

According to one or more embodiments, the geographic information system data includes at least one of: map data; and satellite image data.

According to one or more embodiments, the method includes presenting to the user workstation a visualization of at least a portion of the geographical area. The visualization may be derived from the geographic information system data.

According to one or more embodiments, the identification of the selected catchment from the plurality of catchments within a geographical area is made from the user workstation by a selection of the selected catchment from the visualization.

According to one or more embodiments, the server and the user workstation are coupled to a network enabling the user workstation to access the server from a location remote from the server, and the identification of the selected catchment from the user workstation is received over the network.

According to one or more embodiments, the server and the user workstation are coupled to a network enabling the user workstation to access the server from a location remote from the server, and the identification of the selected catchment from the user workstation is received over the network.

According to one or more embodiments, the multilayered data includes data for each of the plurality of catchments indicating, for any particular catchment: which of one or more catchments adjoining the particular catchment drains into the particular catchment; a stream segment length within the particular catchment; and an average velocity of water within the stream segment.

According to one or more embodiments, automatically selecting from the multilayered data the group of navigated catchments that includes the one or more additional catchments within the group of navigated catchments that drain into the selected catchment includes: for the selected catchment, identifying one or more upstream catch tints from the one or more catchments adjoining the selected catchment that drain into the selected catchment and for each of the one or more or more upstream catchments, identifying all catchments that drain into each of the one or more upstream catchments.

According to one or more embodiments, the multilayered data includes for each catchment in the group of navigated catchments, computing for each catchment in the group of navigated catchments: a travel time to the selected catchment, and a flow volume.

According to one or more embodiments, the travel time for each catchment in the group of navigated catchments is determined relative to each adjoining catchment, and wherein the travel time to the selected catchment accounts for a time lag in flow of water from each catchment in the group of navigated catchments into each next catchment in the group of navigated catchments.

According to one or more embodiments, the travel time for each catchment is computed by dividing the stream segment length by the average velocity within the stream segment.

According to one or more embodiments, the outflow from the selected catchment is determined as a sum of the flow volume from each of the catchments in the group of navigated catchments. The flow volume from each of the catchments in the group of navigated catchments is applied to the outflow according to the travel time for the flow volume of each of the catchments to reach the selected catchment.

According to one or more embodiments, the model presents the outflow of water from the selected location for each increment within the given time period.

According to one or more embodiments, the given time period includes a plurality of days, and each increment within the given time period includes a day.

According to one or more embodiments, the method includes graphically presenting the outflow of water in the model.

According to one or more embodiments, graphically presenting the outflow of water in the model includes presenting at least one of a time series hydrograph, a line graph, and a bar chart.

According to one or more embodiments, the method includes receiving from the user workstation selection of the given time period.

According to one or more embodiments, the method includes storing the model in storage associated with the server.

According to one or more embodiments, the method further includes receiving one or more inputs to alter parameters in at least one of the hydrological data, the geophysical data, and the meteorological data used in the generation of the model; and regenerating the model based on the one or more inputs. Effect of the one or more inputs to alter the parameters on the outflow of water from the selected catchment may he determined.

According to one or more embodiments, the one or more inputs to alter the parameters in at least one of the hydrological data, the geophysical data, and the meteorological data used in the generation of the model include one or more of: precipitation data, temperature data, land use data, soil and other surface type data.

According to one or more embodiments, the one or more inputs to alter the parameters are used in regenerating the model are separately gored within the database of multilayered data.

According to one or more embodiments, a non-transitory computer-readable storage medium storing instructions executable by a computer system to generate multilayered data usable in calculating an outflow of water from a selected catchment. The non-transitory computer-readable storage medium stores instructions to access a database of vectorized polygon data for each of a plurality of catchments within a geographical area, access a database of rasterized data for the geographical area encompassing each of the plurality of catchments within the geographical area, and generate multilayered data by correlating data for each of the plurality of catchments in the vectorized polygon data with the rasterized data corresponding to each of the plurality of catchments.

According to one or more embodiments, the vectorized polygon data includes one or more of hydrological data; soils and other surface type data; and geophysical data.

According to one or more embodiments, the database of rasterized data includes one or more of meteorological data and land use data.

According to one or more embodiments, the instructions include coordinating the multilayered data with geographic information system data visually representing the geographical area.

According to one or more embodiments, the geographic information system data includes at least one of map data and satellite image data.

According to one or more embodiments, the hydrological data, the geophysical data, and the meteorological data are extracted from publicly-available data sources.

According to one or more embodiments, the multilayered data includes data for each of the plurality of catchments including at least precipitation data, temperature data, and land use data.

According to one or more embodiments, a non-transitory computer-readable storage medium storing instructions executable by a computer system to calculate an outflow from a selected catchment into which a plurality of other catchments drain is provided. The non-transitory computer-readable storage medium stores instructions to access a database of multilayered data including vectorized polygon data correlated with rasterized data for each for each of a plurality of catchments within a geographical area. The multilayered data includes for each of the plurality of catchments hydrologic data including a stream segment length and an average velocity of water within the stream segment. The instructions include, for a group of navigated catchments including one or more catchments that drain into a selected catchment, based on the multilayered data and the hydrologic data, determining a flow volume for each catchment in the group of navigated catchments. The instructions include, determining an outflow of the selected catchment determined as a sum of the flow volume from each of the catchments in the group of navigated catchments.

According to one or more embodiments, the instructions automatically identify from the multilayered data the group of navigated catchments that drain into the selected catchment by for the selected catchment, identifying one or more upstream catchments from the one or more catchments adjoining the selected catchment that drain into the selected catchment, and for each of the one or more or more upstream catchments, identifying all catchments that drain into each of the one or more upstream catchments.

According to one or more embodiments, the instructions include determining a travel time for an outflow each catchment in the group of navigated catchments to the selected catchment.

According to one or more embodiments, the travel time for each catchment in the group of navigated catchments is computed relative to each adjoining catchment. The travel time to the selected catchment accounts for a time lag in flow of water from each catchment in the group of navigated catchments into each next catchment in the group of navigated catchments.

According to one or more embodiments, the travel time for each catchment is computed by dividing the stream segment length by the average velocity within the stream segment.

According to one or more embodiments, the instructions include determining the outflow of the selected catchment by applying the outflow of each catchment in the group of navigated catchments according to the travel time for the outflow of each catchment.

According to one or more embodiments, a computer device having computer control code thereon is provided. The computer control code is configured to identify a selected catchment from a plurality of catchments within a geographical area, receive, from a database, multilayered data for each of the plurality of catchments within the geographical area, selecting a group of navigated catchments that drain into a selected catchment from the plurality of catchments within the geographical area, and generating a model determining one of more characteristics of the catchment based on the selected group of navigated catchments and the multilayered database. The one or more characteristics may be a flow of water, a length of a catchment, a time period, or any other characteristic described herein.

According to one or more embodiments, a computer-implemented method of calculating an outflow of water from a selected catchment is provided. The computer-implemented method includes at a computer, receiving an identification of a selected catchment from a plurality of catchments within a geographical area, accessing a database of multilayered data for each of the plurality of catchments within the geographical area, selecting a group of navigated catchments including one or more additional catchments that drain into the selected catchment from the plurality of catchments represented in the multilayered data, and generating a model determining an outflow of water from each of the group of navigated catchments resulting in a determination of an outflow of water from the selected catchment.

A computer-implemented method of determining one or more characteristics of a selected catchment is provided. The computer-implemented method includes, at a computer: receiving an identification of a selected catchment from a plurality of catchments within a geographical area, accessing a database of multilayered data for each of the plurality of catchments within the geographical area, generating a model determining a characteristic of a selected one or more catchment of the plurality of catchments.

Other aspects, features and embodiments of the disclosure will be more fully apparent from the ensuing disclosure and appended claims.

### BRIEF DESCRIPTION OF THE DRAWINGS

FIG. 1 is a schematic diagram of an embodiment of a system to facilitate the generation of multilayered data and to calculate an outflow from a selected catchment;

FIG. 2 is a symbolic diagram representing vectorized polygons representing hydrological data being correlated with rasterized data representing geophysical data;

FIG. 3 is a flow diagram of an embodiment of a method performable by instructions executable by a computer system to generate multilayered data usable in calculating an outflow of water from a selected catchment;

FIG. 4 is a flow diagram of an embodiment of a method performable by instructions executable by a computer system to calculate an outflow from a selected catchment into which a plurality of other catchments drain;

FIG. 5 is a flow diagram of an embodiment of a computer-implemented method of calculating an outflow of water from a selected catchment;

FIG. 6 is a screen representation of a browser application used to access a resource that performs a computer-implemented method to calculate an outflow from a selected catchment according to at least one embodiment;

FIG. 7 is a screen representation of the browser application of FIG. 6 showing a first result of defining a watershed of the selected catchment;

FIG. 8 is a screen representation of the browser application of FIG. 6 displaying a representation of the outflow from the selected catchment;

FIGS. 9A through 9C are additional forms of visual representations of an outflow that may be generated by an embodiment of a computer-implemented method to calculate an outflow from a selected catchment;

FIG. 10 is an additional screen representation of an embodiment of a computer-implemented method to calculate an outflow from a selected catchment; and

FIG. 11 is an additional screen representation of an embodiment of a computer-implemented method to calculate an outflow from a selected catchment.

### DETAILED DESCRIPTION

The present disclosure relates to computer-implemented methods and non-transitory computer readable storage media to facilitate calculating outflow of water from a selected catchment. Hydrological data, geophysical data, and meteorological data are combined into multilayered data to facilitate automated watershed analysis. By identifying for a selected catchment which catchments drain into said catchment, and by determining a volume of water generated in each of the upstream catchments an outflow of water from the selected catchment is determined. Using the model, data regarding precipitation, land use changes, and other inputs may be manipulated to determine an effect the changes have on the outflow.

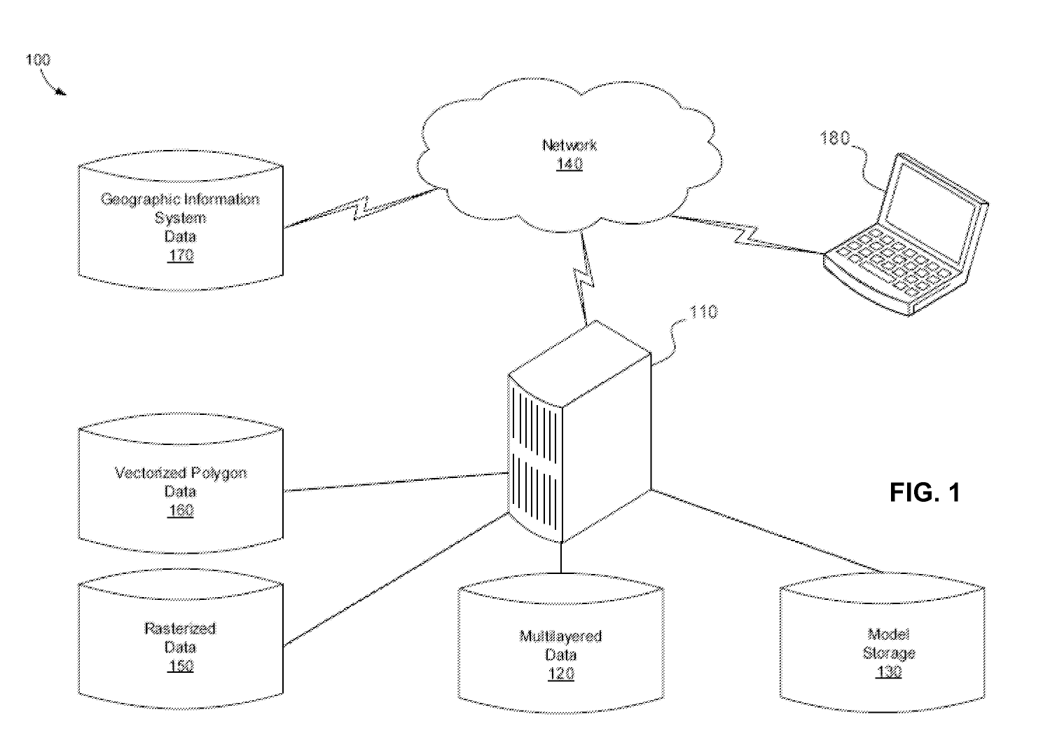

FIG. 1 is a schematic diagram of an embodiment of a system 100 to facilitate the generation of multilayered data and to calculate an outflow from a selected catchment. As used in many examples provided herein, catchment may refer to an extent of land where water from precipitation drains into a body of water. In a particular embodiment, the generation of data and calculation are performed by a server 110. The server 110 may be cloud or non-cloud based and may be communicatively coupled with one or more modules that are not illustrated in the one or more examples of FIG. 1. The server 110 may be coupled to our or more storage banks including, for example, rasterized data storage 150, vectorized polygon data storage 160, multilayered data storage 120, and model storage 130. Each of these storage modules is providing for storing data received from other sources as disclosed herein or from server 110. Via the network 140, the server 110 is communicationally coupled to geographic information system data 170. Via the network 140, the server 110 is also communicationally coupled to the workstation 180.

The generation of multilayered data and calculations thereon may be performed on the server 110 for at least two reasons. First, as further described below, preprocessing the data to prepare the multilayered data may require significant processing and storage requirements. Multilayered data as used herein refers to data from multiple sources or of multiple types. For example, multilayered data may refer to data from the rasterized data module 150 and the vectorized polygon data module 170. Preprocessing the data on the server 110 takes advantage of what may be greater processing capacity and storage capacities than are available on, for example, workstation 180. Second, by preprocessing and maintaining the multilayered data on the server 110, users can access the multilayered data and perform calculations on the data as a service, without having to generate or maintain the multilayered data on their own workstations. This may allow for greater portability of measurements in the field and provide access to data to a greater number of authorized users.

The rasterized data 150 and the vectorized polygon data 160 constitute large stores of data that generally are publicly available. The vectorized polygon 160, for example, may include hydrological data from the National Hydrography Dataset Plus, or NHDPlus, made available by the U.S. Environmental Protection Agency (“USEPA”). The NHDPlus data includes data on every catchment in the continental United States, including information on stream segment lengths, average water velocity, and other information. The vectorized polygon data 160 also may include data available from Federal Agencies. The vectorized polygon data 160 may include information on land use, soil or other cover types, etc. By correlating the rasterized data 150, that describes the land use and meteorological condition associated with specific geographic areas with the vectorized polygon data 160, that describes the catchment and hydrological data as well as the soils conditions associated with specific geographic areas, accurate models of watershed activity for selected portions of the land may be generated.

Embodiments of the disclosure may also coordinate and overlay the rasterized data 150 and the vectorized polygon data 160 with geographic information system data 170. The geographic information system data 170 includes map or satellite image data that provides a visual representation of the land to help identify catchments of interest with regard to borders, landmarks, or visual cues from the land. As described further below, the geographic information system data 170 thus aids a user of the system 100 in selecting catchments of interest to be used in modeling watershed activity. In a particular embodiment, the geographic information system data 170 is accessed over the network 140 and correlated with the vectorized polygon data 160 and the rasterized data 150 at the server 110. However, it should be appreciated that all of the rasterized data 150, the vectorized polygon data 160, and the geographic information system data 170 could be accessed via a network, all of the data could be stored locally at the server 110, or the data could be accessed over a network and from local sources in any by any number of combinations.

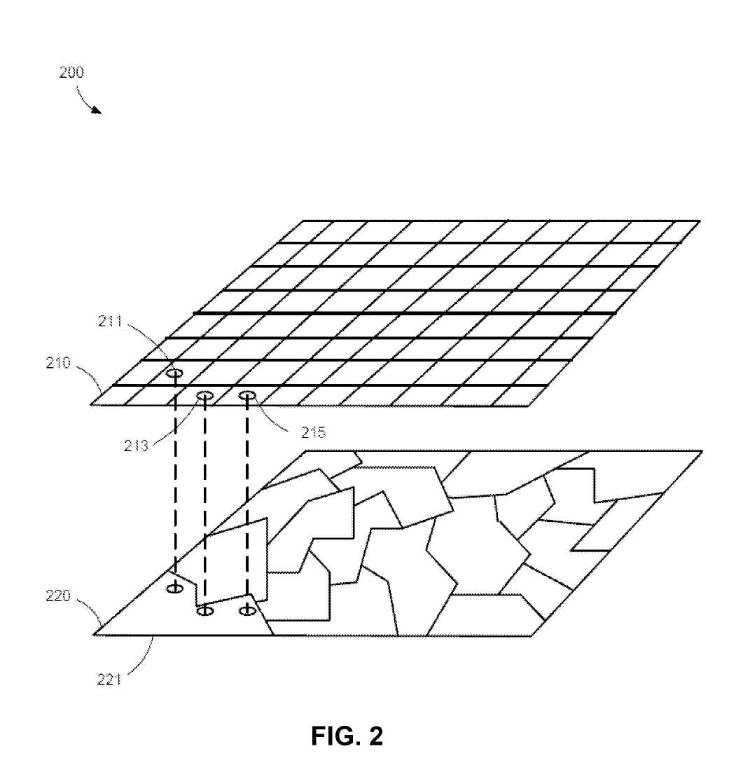

A problem in correlating rasterized data 150, vectorized polygon data 160, and/or geographic information system data is that the different types of data are associated with the land that each represents in different ways. Embodiments of the disclosure are configured to correlate the different types of data to overcome the representational differences, as described below with reference to FIG. 2.

FIG. 2 is a symbolic diagram representing vectorized polygons 220 representing catchment and hydrological data being correlated with rasterized data 210, such as meteorological data. FIG. 2 visually represents the problem in correlating the different types of data in that, for example, the catchment and hydrological data 220 may be represented by, irregular shapes or vectorized polygons 220, such as polygon 221, which represent the boundaries of each physical catchment in a geographical area. By contrast, the meteorological data is represented in Cartesian-coordinate-like raster data 210 in which an area is divided into rows and columns.

A single catchment may overlap multiple columns or rows of the rasterized data 210. For example, a selected catchment represented by vectorized polygon 221 may overlap several different raster cells including, for example, raster cells 211, 213, and 215. Vectorized polygons representing other catchments may overlap a greater or smaller number of raster cells, and will overlap raster cells in a different pattern than those overlapped by the vectorized polygon 211. Embodiments of the disclosure overcome these different types of association to correlate the data represented within the differently-associated types of data, as further described below.

In a particular embodiment, input includes “shapefiles” data in an ESRI format devised by the Environmental Systems Research Institute, are used to describe the vectorized polygons in the catchment and hydrological data. Additional input includes “raster” data that is recognized by many publicly available the formats, including GeoTIFF and Big TIFF formats. Output includes text files of tabular output to relate the relationship between each vectorized polygon and the raster coordinates or “cells” where each vectorized polygon intersects a raster cell.

In a particular implementation, the data is generally correlated using quad tree segmentation. Attention is given to handling that edges of vectorized polygons that may intersect multiple raster cells and how the vectorized polygons should be apportioned among multiple intersecting raster cells. The methodology is an improvement over StarSpan geospatial coordination software. In a particular implementation, the method may be implemented in Java or other computer control code stored to a non-transitory computer-readable storage medium.

The aforementioned code may be used to correlate the vectorized polygon data of the catchment and hydrological data 220 with the rasterized data 210. Similarly, the vectorized polygon data of the catchment and hydrological data 220 may be coordinated with the rasterized geographic information system data 210, or the rasterized geographic information system data 210 may be directly coordinated with the tabular, raster-coordinated data output by the one or more methods described herein.

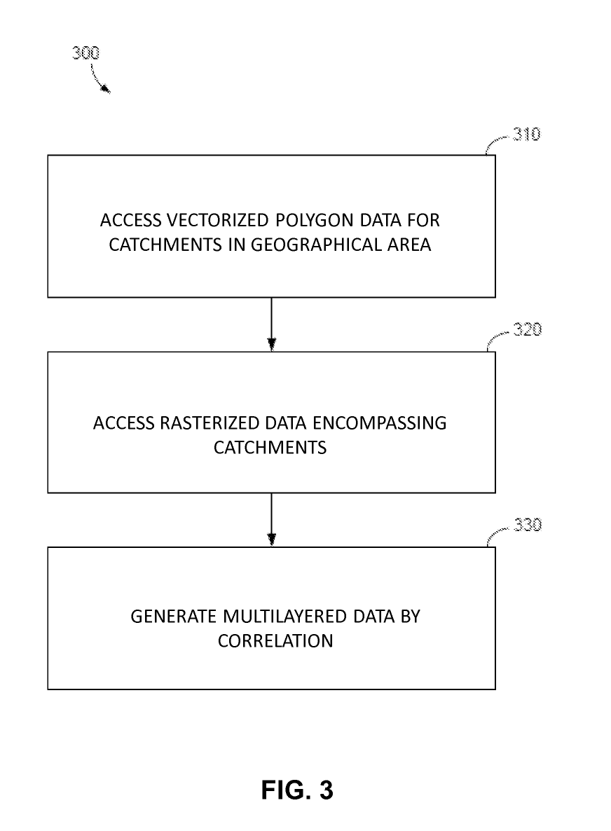

FIG. 3 is a flow diagram of an embodiment of a method 300 performable by instructions executable by a computer system to generate multilayered data usable in calculating an outflow of water from a selected catchment, such as previously described. In particular embodiments, the method 300 may be executed on a server 110 (FIG. 1), such as by utilizing the method of FIG. 2, by using the computer control code described herein. The resulting multilayered data is stored in the multilayered data storage module 120. In one implementation, multilayered data including correlated rasterized data from module 150 and vectorized polygon data from module 160 is accessed local to server 110 and is preprocessed and stored in the multilayered data storage module 120 for ready access by the server 110.

At 310, a database of vectorized polygon data for each of a plurality of catchments within a geographical area is accessed. Thus, for example, as shown in FIG. 1, the server 110 may access the vectorized polygon data 160 from local storage, the vectorized polygon data may be accessed over the network 140 (not specifically shown in FIG. 1), or a portion thereof may be made and stored to local storage multilayered data storage 120. At 320, a database of rasterized data encompassing each of the plurality of catchments within the geographical area is accessed. Thus, for example, the server 110 may access the rasterized data 150 directly from local storage, as shown in FIG. 1, the rasterized data from module 150 may be accessed over the network 140 (not specifically shown in FIG. 1), or a copy of the rasterized data from module 150 or a portion thereof may be made and stored to local storage multilayered data storage 120. Network 140 may be a wireless network such as WLAN or cellular, a wired network operating over any appropriately configured wired network, or a combination thereof.

At 330, multilayered data is generated by correlating data for each of the plurality of catchments in the vectorized polygon data with the rasterized data corresponding to each of the plurality of catchments. As previously described with reference to FIG. 2 and the following exemplary code, the data representing each of the plurality of catchments within the geographical area, represented by vectorized polygons in the catchment and hydrological data and the soils conditions and other geophysical data, and the data representing each of the plurality of catchments within the geographical area, represented by rasterized data from module 150 in the meteorological data and land use data, are stored in multilayered data from module 120. The resulting multilayered data is written to the multilayered data storage 120.

While in the embodiment illustrated in FIG. 3, the vectorized data is received 310 before rasterized data 320, in appropriate embodiments, the order may be altered, other processing steps may be employed if desired.

As previously described, an object of embodiments of the present disclosure is to determine an outflow from a selected catchment. The previously-described method of correlating hydrological data, geophysical data, and meteorological data may be useful in generating the multilayered data that provides a basis for calculating the flow of water through any particular catchment. Another useful aspect of calculating the outflow of a catchment is to account for the time required for water flowing from upstream catchments that drain into a particular catchment to impact the flow at the particular catchment. The catchment and hydrological data may include, for each particular catchment, a reference to those catchments that drain into that particular catchment. Accordingly, from a selected catchment, one can back trace through the data identifying the upstream catchments to determine which catchments drain into the selected catchment. However, it is useful to have a process that determines the flow of water that reaches the selected catchment and when that flow will reach the selected catchment.

In a particular implementation, the calculation of outflow from a catchment may rely on a ‘rainfall-runoff’ hydrologic model which utilizes daily precipitation as a forcing factor for deriving the flows across a land surface and subsurface that contribute to the daily outflow (time=t). Err such a model the outflow for a catchment is the summation of runoff (Qₜ) across all the and uses within the catchment and groundwater discharge (Gₜ) for the overall catchment.

In a particular implementation, the runoff component may be calculated based on the U.S. Soil Conservation Service's Curve Number Equation (Ogrosky & Moekus, 1964) over each land use within a catchment for each day (t) of the simulation, as presented in Eq. (1):

$${Q}_{t} = \frac{{( {R}_{t} + {M}_{t} - 0.2 * {DS}_{t} )}^{2}}{{R}_{t} + {M}_{t} + 0.8 * {DS}_{t}} \qquad ( 1 )$$

In Eq. (1), rainfall (Rₜ) values are queried from the multilayered data for the particular catchment, while snow melt (Mₜ) can be estimated as a linear function of temperature (Tₜ), a value also queried from the multilayered data for the particular catchment.

The detention parameter (DSₜ) within each land use may be determined from a curve number (CNₜ) as presented in Eq. (2):

$${DS}_{t} = \frac{2540}{{CN}_{t}} - 25.4 \qquad ( 2 )$$

Curve numbers may be calculated as functions of three sets of antecedent moisture conditions 1 (driest), 2 (average) and 3 (wettest) (CN1, CN2, and CN3, respectively). The actual curve number for day t (CNₜ) is selected as a linear function of 5-day antecedent precipitation (Aₜ), as presented in Eq. (2):

$${A}_{t} = {\sum }_{n = t - 5}^{t - 1} ( {R}_{n} + {M}_{n} ) \qquad ( 3 )$$

Break points in between the three antecedent moisture conditions that are used to selected between CN1, CN2, and CN3 may be set based on literature values or through model calibrations and may also depend on leaf on or leaf off conditions for a particular implementation. During days with snowmelt, CN3 is automatically selected to indicate that the wettest antecedent moisture conditions prevail. Further adjustments to the selected curve number may be based on the antecedent moisture volumes.

A value for CN2 for each land use within a catchment is selected from the multilayered data. Values for CN1 and CN3 are computed from Hawkins (1978) approximations, as presented in Eq (4) and (5):

$$\begin{matrix}CN 1 = \frac{CN 2}{2.334 - 0.01334 * CN 2} & ( 4 ) \\ CN 3 = \frac{CN 2}{0.4036 - 0.0059 * CN 2} & ( 5 )\end{matrix}$$

Groundwater discharge for catchment may be calculated based on the subsurface conditions within unsaturated, shallow saturated, and deep saturated zones where discharge from the shallow saturated zone contributes flow to the outflow of the catchment. A daily water balance on the unsaturated and shallow saturated zones may be described by the following calculations which link the surface runoff to the subsurface, as presented in Eqs. (6) and (7):

Uₜ₊₁=Uₜ+Rₜ+Mₜ−Qₜ−Eₜ−PCₜ (6)

Sₜ₋₁=Sₜ+PCₜ−Gₜ−Dₜ (7)

The volume of water within the unsaturated zone. (Uₜ₊₁) is a function of the volume of water within the zone on the previous day (Uₜ), snowmelt, surface runoff over the whole catchment, evapotranspiration (Eₜ), and percolation to the saturated zone (PC₁). The volume of water within the saturated zone (Sₜ₊₁) is a function of the volume of water within the zone on the previous day (Sₜ), percolation, volume of water lost to the deep saturated zone (Dₜ), and groundwater discharge to the stream (Gₜ).

Evapotranspiration (Eₜ) may be calculated as a function of temperature, a cover factor relating to the land use within the catchment, and the number of daylight hours per day during the month of the simulation. All three components may be queried, from the multilayered data. Evapotranspiration is also limited by the volume of water within the unsaturated zone.

Percolation occurs when unsaturated zone water exceeds available soil water capacity (AWC), a value queried from the multilayered data and adjusted upon calibration as needed, as presented in Eq. (8):

PCₜ=Max(0;Uₜ+Rₜ+Mₜ−Qₜ−Eₜ−AWC) (8)

The shallow unsaturated zone may be modeled as a simple linear reservoir. Groundwater discharge and deep seepage may be calculated as linear functions of the volume of water in the shallow saturated zone, as presented in Eqs. (9) and (10):

Gₜ=r*S, (9)

and

Dₜ=s*S, (10)

In Eqs. (9) and (10), r and s are groundwater recession and seepage constants, respectively, which are queried from the multilayered data and adjusted upon calibration as needed.

To determine the time at which the outflow calculated from the above methods for a particular upstream catchment is applied at the selected catchment one may use a modified lag routing approach with the navigated catchments that drain into a selected catchment. In a particular implementation, the method assumes a constant lag that depends on an average velocity and distance of a catchment from a pour point (i.e., the selected catchment), which are values queried from the multilayered data. This procedure thus accounts for the water flowing from the navigated catchments and conserves the volume of the water generated over the period of time by keeping a record of water that has not yet reached the selected catchment at a given time, but applies the flow at the appropriate later time.

For each catchment in the list of navigated catchments, the travel time (T) (e.g., in days) from the catchment to the selected, most downstream catchment is calculated using stream segment length (L) (e.g., in meters) and average velocity (V) (e.g., in meters per day). Thus, the travel time may be calculated according to Eq. (11):

T=L/V (11)

In one embodiment, the time T is rounded to the nearest integer. The stream length and average velocities are available in the hydrological data, such as the NHDPlus database to supply the values of L and V for the calculation of Eq. (11). Once the flow volume is determined for each catchment, the calculated time lag is applied to add the flow for each catchment at the appropriate time.

For example, an exemplary catchment, C12, has eleven upstream catchments, C1-C11, that eventually drain into the selected catchment C12, where C1 is the most remote upstream catchment and C11 is the most proximate catchment. In one particular implementation, the time for water to flow from one catchment to another is rounded to the nearest day. Thus, for example, the lag time for water to flow from catchment C11 to C12 is zero days, because the flow from C11 passes directly into C12. The lag time for water to flow from C9 and C10 may be one day. The lag time from C8 may be two days. The lag time for water to flow from C3 through C7 may be three days. The lag time for water to flow from C1 and C2 to C12 may be four days. Applying the outflow from the selected catchment C12 is computed according to Eq. (12), where “t” is the current day and the calculated time lags are substituted appropriately (F represents the flow from each catchment):

FC12(t)=FC1(t−4)+FC2(t−4)+FC3(t−3)+FC4(t−3)+FC5(t−3)+FC6(t−3)+FC7(t−3)+FC8(t−2)+FC9(t−1)+FC10(t−1)+FC11(t)+FC12(t) (12)

At the start of the calculation, t=1. Accordingly, flow volumes from catchments that have lags (e.g., C1 through C10) would not be available. However, values from a selected “spin-up year” may be used to provide representative flow values to be applied for those days before the actual calculated flows will be applied.

The same process is used for any catchment within the group of navigated catchments. For instance, in the previous example, to calculate the inflow to catchment C10, all the flows upstream of C10 are summed to account for travel time that is relative to C10, rather than C12. Thus, the travel times of all the catchments upstream of C10 are adjusted by taking the difference between the cumulative travel times of each of the catchment to C12 and the travel time of C10. In this example, the travel time of C10 is 1 day. Thus the relative travel times for all catchments that drain to C10 are reduced by 1day, as shown in Eq. (13):

FC10(t)=FC1(t−4−1)+FC2(t−4−1)+FC3(t−3−1)+FC4(t−3−1)+FC5(t−3−1)+FC6(t−3−1)+FC7(t−3−1)+FC8(t−−1)+FC9(t−1−1) (13)

Solving the arithmetic, Eq. (13) may be rewritten as Eq. (14):

FC10(t)=FC1(t−3)+FC2(t−3)+FC3(t−2)+FC4(t−2)+FC5(t−2)+FC6(t−2)+FC7(t−2)+FC8(t−1)+FC9(t) (14)

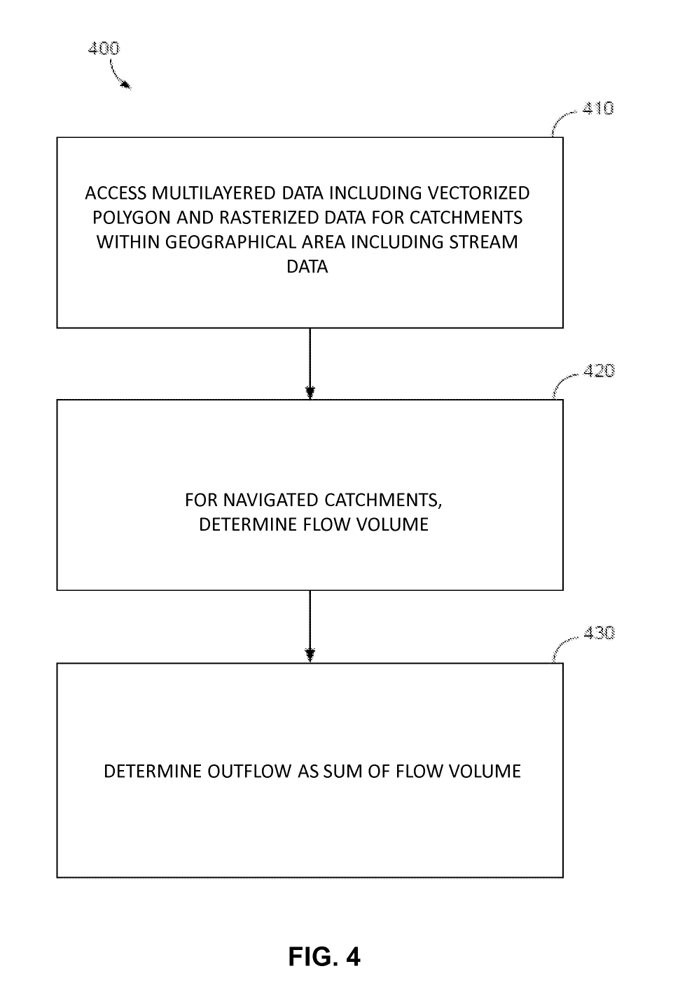

FIG. 4 is a flow diagram of an embodiment of a method 400 performable by instructions executable by a computer system to calculate an outflow from a selected catchment into which a plurality of other catchments drain as previously described. The computer implemented method 400 may be executed on a server 110 (FIG. 1).

At 410, a database of multilayered data including hydrological data correlated with geophysical and meteorological data for each for each of a plurality of catchments within the geographical area is accessed. The multilayered data includes hydrologic data for each of the plurality of catchments including, a stream segment length and an average velocity of water within the stream segment to facilitate calculation of a travel time or time lag for a flow of each catchment reaching a selected catchment. At 420, for a group of navigated catchments including one or more catchments that drain into a selected catchment, a travel time to the selected catchment based on the hydrologic data, including stream segment length and the average velocity of water within the stream segment, is calculated. At 430, an outflow of the selected catchment is determined as a sum of the flow volume, as determined by the hydrologic model, from each of the catchments in the group of navigated catchments. Optionally, the flow volume from each of the catchments in the group of navigated catchments is applied to the outflow according to the travel time for the flow volume of each catchment in the group of navigated catchments to reach the selected catchment.

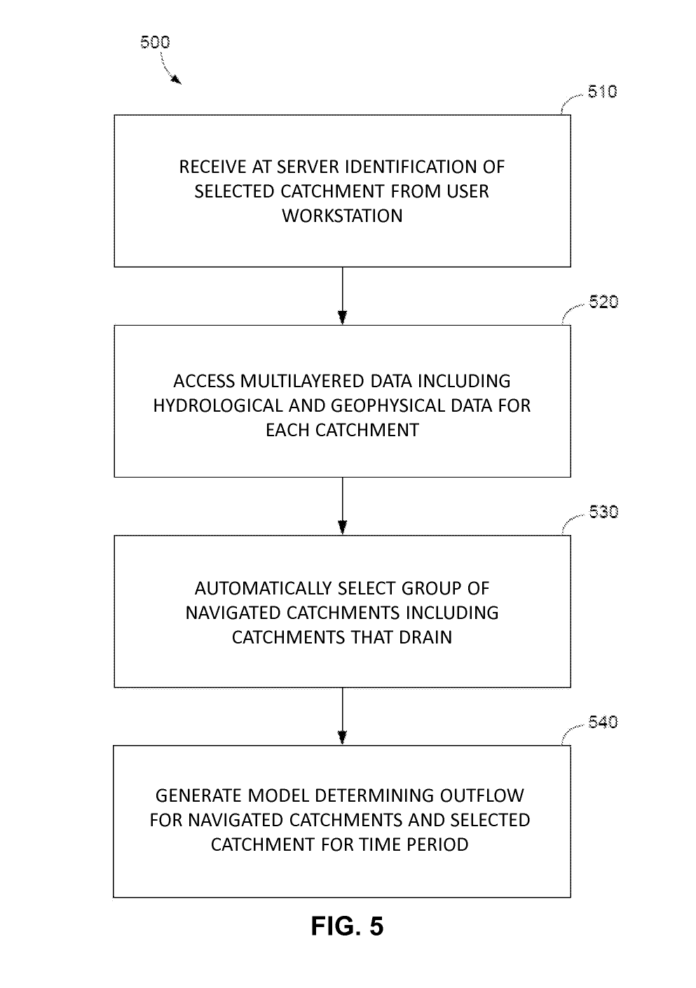

Taking advantage of the methods as previously described with reference to FIGS. 2 through 4, embodiments of the present disclosure enable automatic calculation of an outflow of a selected catchment and all identified upstream catchments as described with reference to FIGS. 5 through 11.

FIG. 5 is a flow diagram of an embodiment of a computer-implemented method 500 of calculating an outflow of water from a selected catchment. The computer-implemented method 500 may be executed on a server 110 (FIG. 1) that may receive input from a workstation 180 that may be locally-coupled to the server 110 or remotely communicationally-coupled to the server 110 over a network 140 as well over network 140 communicationally-coupled to geographic information system data 170. Alternatively, in one or more embodiments, the workstation 180 may contain each data source disclosed herein on physical memory provided on the workstation 180 and can execute the one or more methods disclosed herein at the workstation 180 without access to external data modules. In one implementation, multilayered data including correlated hydrological, geophysical, and meteorological data from rasterized and vectorized polygon data is preprocessed and stored in the multilayered data storage 120 for ready access by the server 110. A model generated by the server 110 may be stored by the server 110 in the model storage 130 for further use or manipulation, as further described below.

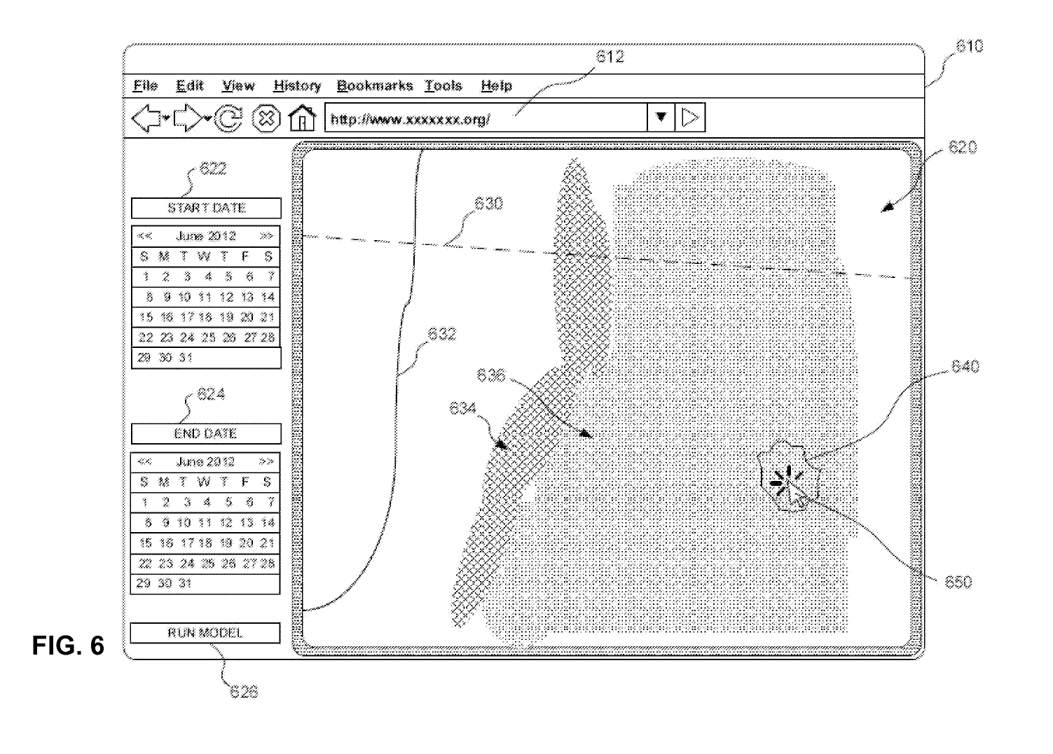

At 510, at a server, an identification of a selected catchment from a plurality of catchments within a geographical area is received from a user workstation. As described with reference to FIG. 6, the selected catchment may be identified at the workstation 180 using a graphical user interface to allow the user to visually choose the selected catchment. At 520, a database of multilayered data that may include hydrological data, geophysical data, and meteorological data for each of the plurality of catchments within the geographical area is accessed by the server. As previously described with reference to FIGS. 2 and 3, the multilayered data may be generated by preprocessing hydrological, geophysical, and meteorological data to correlate those bodies of data. The resulting preprocessed, multilayered data may be stored in multilayer data storage 120 for ready access by the server 110.

At 530, a group of navigated catchments including one or more additional catchments within the plurality of catchments that drain into the selected catchment are selected by the computer control code. This selection may be automatic. As previously described, the catchment and hydrological data included in the multilayered data includes data identifying upstream catchments that drain into each particular catchment. Back tracing this information from a selected catchment enables identification of all of the navigated catchments that drain into the selected catchment. At 540, a model is generated that determines an outflow of water from each navigated catchment resulting in determination of an outflow of water from the selected catchment for a given time period. The results of the model may be presented on the workstation 180 where the model may be studied. The model also may be saved by the server 110 (e.g., in model storage 130) for later study and/or manipulation, as further described below.

In a broader application of the method just described, a computer-implemented method of determining one or more characteristics of a selected catchment is provided. The computer-implemented method includes, at a computer: receiving an identification of a selected catchment from a plurality of catchments within a geographical area accessing a database of multilayered data for each of the plurality of catchments within the geographical area, generating a model determining a characteristic of a selected one or more catchment of the plurality of catchments. Accessing a database may include accessing a database for each of the plurality of catchments within the geographical area where the database included multilayered data of hydrological data, geophysical data, and meteorological data.

FIGS. 6, 7, 8, 10 and 11 are screen representations of an embodiment of a computer-implemented method to calculate an outflow from a selected catchment. FIG. 6 shows a browser application 610 that is used to access a resource (at a resource location 612) that performs the computer-implemented method. As previously described, for multiple reasons it may be desirable to execute the method on a server, such as server 110 (FIG. 1), and access the server 110 from a workstation 180. Via the browser 610 executing on workstation 180 communicationally-coupled to the server 110 is one way to enable workstation access to the compute-implemented method executed on the server.

The browser displays four predominant features: a map window 620, a define watershed selection 621, a start date selector 622, an end date selector 624, and a run model selection 626. The map window 620 describes a geographical area of interest selectable by a user to perform watershed analysis. The define watershed selection 621 enables a user to define the group of catchments upstream of the selected catchment in the map window 620. The start data and end date selectors 622 and 624 enable the user to select a time period of interest for the watershed analysis. The run model selection 626 enables a user to run then model and then manipulate underlying parameters to perform “what-if” analysis to study effects of changes in climate, land use, and other factors in additional model runs. Each of these features is described further below.

The map window 620 shows a geographical region of potential interest to the user. In a particular embodiment, the geographical region is presented using one or more of map data or satellite image data. Map data, for example, may show references such as a territorial border 630 or a highway 632 to help orient the user as to the geographical region of interest. Map data and/or satellite data may also depict geophysical features, such as different types of terrain or ground cover 634 and 636.

From the map window 620, the user may initiate a watershed analysis by identifying a selected catchment 640, such as by selecting it with a cursor 650 via a graphical user interface, and selecting define watershed 621. If a period of interest is given or has been pre-selected, the sole act of defining the watershed for the selected catchment 640 is sufficient to initiate generation of the model at the server 110 (FIG. 1).

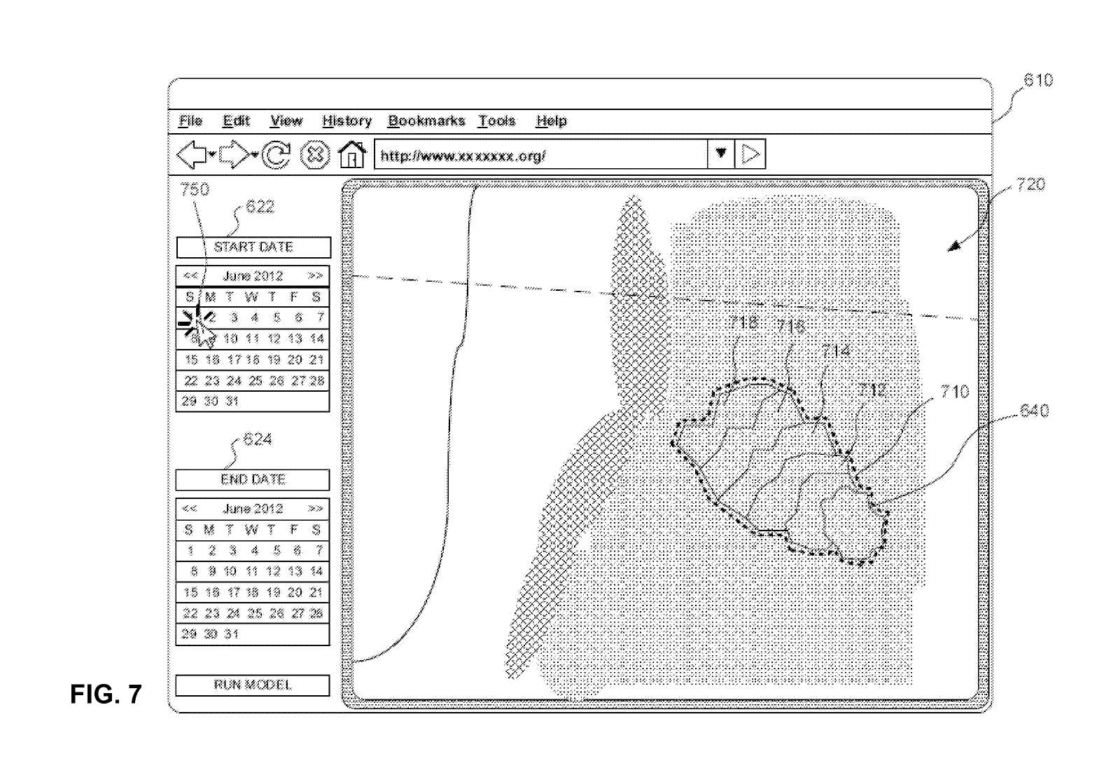

FIG. 7 shows a first result of defining the watershed of the selected catchment. An updated map 720 may be presented to show the group of navigated catchments 710, 712, 714, 716, and 718 that drain into the selected catchment 640. As previously described, the catchment and hydrological data included in the multilayered data generated and maintained at the server 110 may include references for each catchment that identify all upstream catchments. Back tracing the references enables identification of the group of navigated catchments that drain into the selected catchment 640. FIG. 7 also shows that, using the cursor 750, the user may manipulate the start date 622 to change the period of study. (The user similarly may manipulate the cursor 750 to modify the end date 634). Provided with the selected catchment and given or selected start and end dates, the computer-implemented method then generates a model to represent an outflow of the selected catchment.

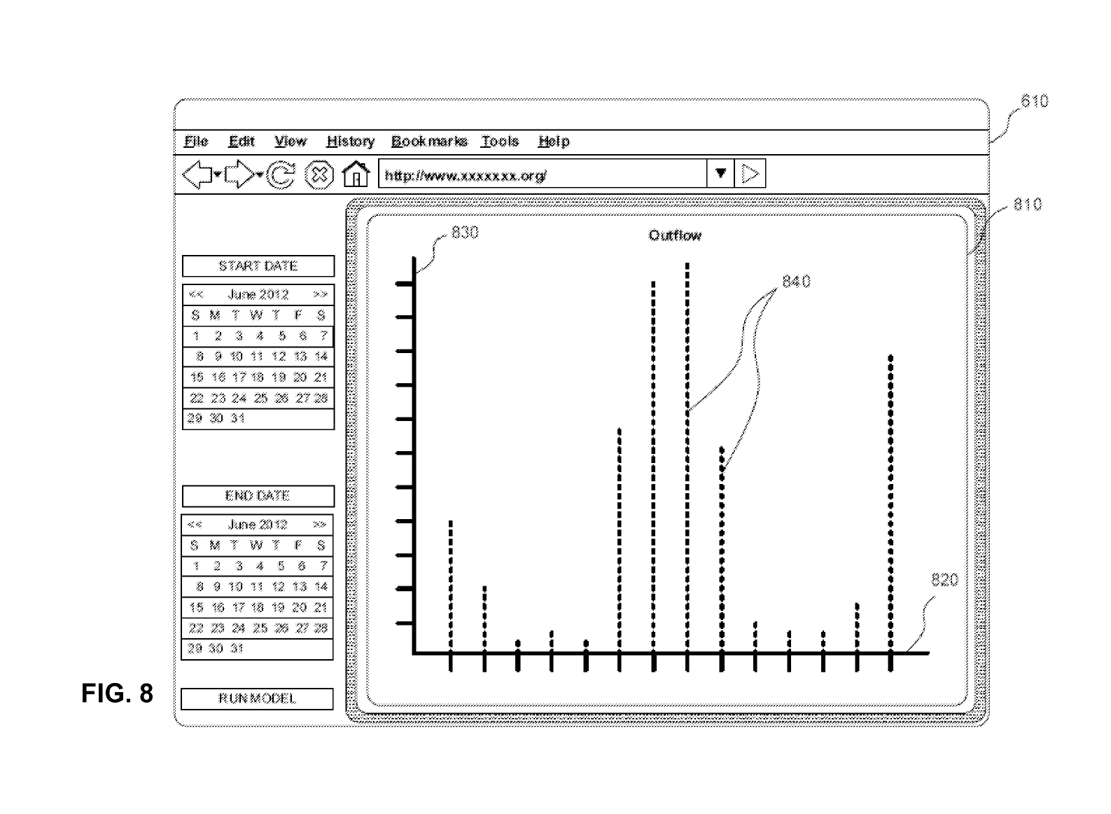

FIG. 8 shows a result of the model as generated by the computer-implemented method. In particular, the browser 610 now displays a representation of the outflow from the selected catchment 810, presented in the form of a line graph. In the time series hydrograph, for time periods plotted on an independent x-axis 820 (e.g., days), the outflow from the selected catchment is plotted on a dependent y-axis 830. A plotted line 840 visually depicts the outflow for each plotted period.

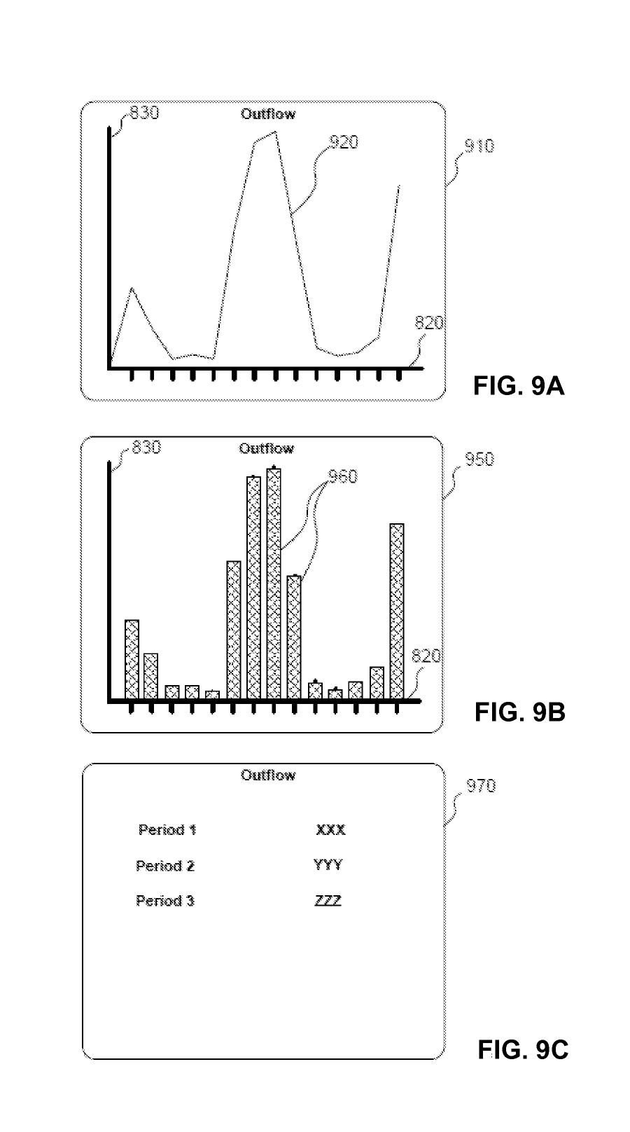

FIGS. 9A through 9B illustrate other forms of visual representations that may be generated by the model to represent the outflow from the selected catchment. As shown in FIG. 9A, instead of a line graph, for example, a user may be presented with a bar graph 910 that uses bars 920 to represent the flow for each period. In addition, as shown in FIG. 913, the user may be presented with outflow data in a table 930 that lists an outflow for each period. In addition, FIG. 9C shows a flow duration curve 950 that may be generated. An x-axis 960 depicts a probability, which may be expressed as a percentage, and a y-axis 970 depicts an outflow. A plot 980 represents an expected probability that a certain magnitude of flow will be experienced during a simulation period, and the flow duration curve may represent extreme low and high flows that may result during the period.

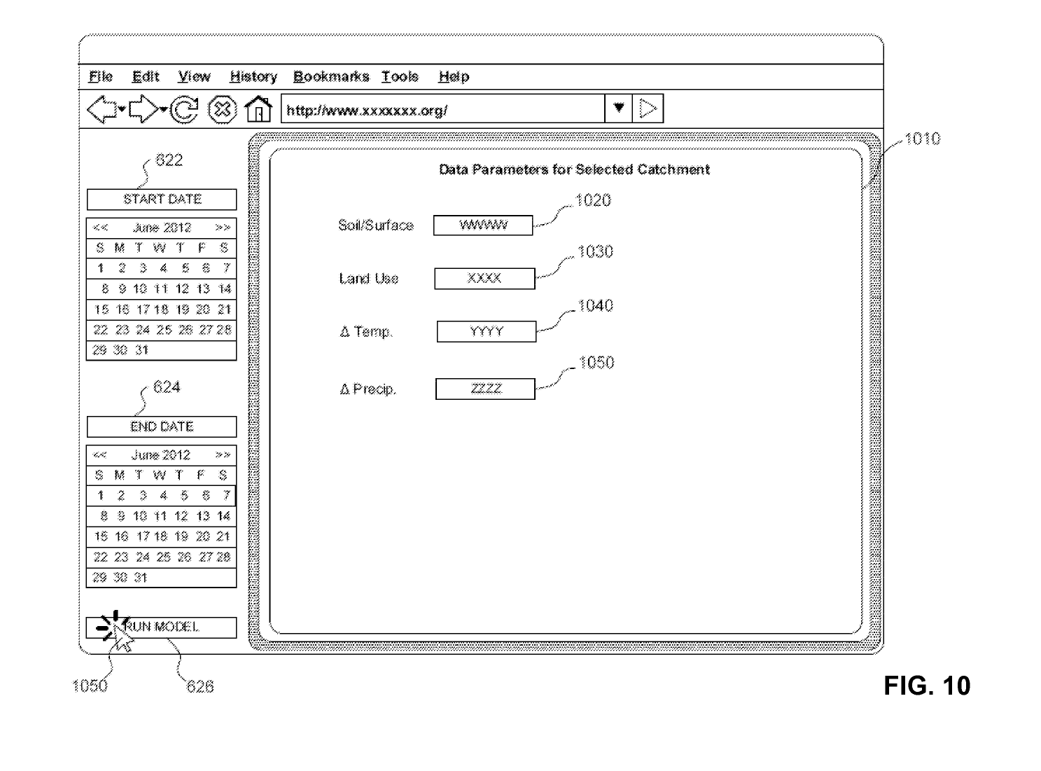

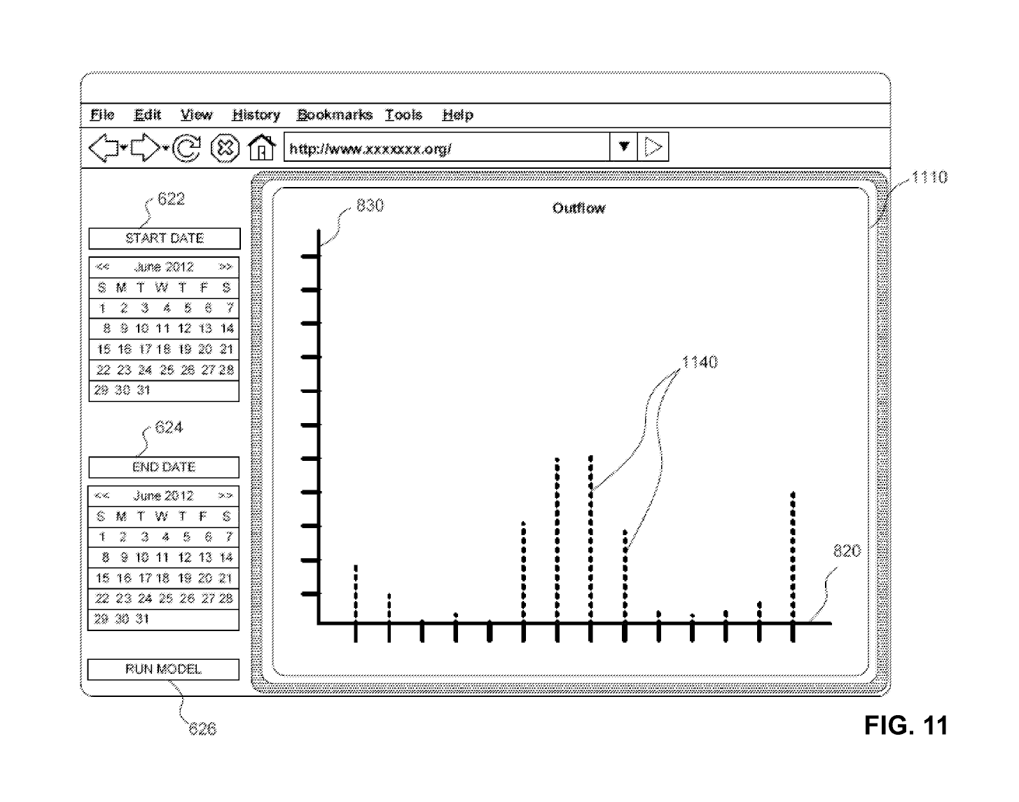

FIG. 10 shows another screen representation which, in response to user selection of the run model option 626 (which may be selected with a cursor 1050), the user may be presented with access to an input window 1010 that indicates the parameters used in calculating the model. From the input window 1010, the user may change one or more inputs, such as soil or surface type 1020, land use type 1030, change in temperature 1040, or change in precipitation 1050, or any other parameters used in the calculation. The model will then be recomputed according to the changed parameters, as shown in FIG. 11. The resulting representation of the outflow 1110 includes a line or plot 1140 that depicts outflows that show a significant flow reduction, as compared with the flows depicted in FIG. 8, which showed the outflow 810 according to the original parameters. Thus, for example, a user may learn of minor or major changes in outflow of the selected catchment based on changes in land use, climate, or any other factor used in the calculation of the outflow. The user may continue to manipulate the model by changing the start date 622, the end data 624, or modifying other parameters using the run model option 626

While embodiments have been has been described herein in reference to specific aspects, features and illustrative embodiments of the disclosure, it will be appreciated that the utility of the embodiments is not thus limited, but rather extends to and encompasses numerous other variations, modifications and alternative embodiments, as will suggest themselves to those of ordinary skill in the field, based on the disclosure herein. Correspondingly, the embodiments as hereinafter claimed are intended to be broadly construed and interpreted, as including all such variations, modifications and alternative embodiments, within their spirit and scope.

What is claimed is:

1. A computer-implemented method of calculating an outflow of water from a selected catchment, the computer-implemented method comprising:
at a server computer:
receiving from a user workstation an identification of a selected catchment from a plurality of catchments within a geographical area;
accessing a database of multilayered data for each of the plurality of catchments within the geographical area;
automatically selecting a group of navigated catchments including one or more additional catchments that drain into the selected catchment from the plurality of catchments represented in the multilayered data; and
generating a model determining an outflow of water from each of the group of navigated catchments resulting in a determination of an outflow of water from the selected catchment for a given time period.

2. The computer-implemented method of claim 1, wherein the multilayered data includes at least two of hydrological data, geophysical data, and meteorological data, and for each of the plurality of catchments including at least one of precipitation data, temperature data, land use data, and soil and other surface type data.

3. The computer-implemented method of claim 2, wherein the hydrological data, the geophysical data, and the soil and other surface type data includes vectorized polygon data, wherein each of a plurality of vectorized polygons represents one of a catchment and another land area that includes one or more catchments.

4. The computer-implemented method of claim 3, wherein the meteorological data and the and use data include rasterized data, wherein each of the meteorological data and the land use data are associated with a rasterized location within the raster data.

5. The computer-implemented method of claim 4, further comprising generating the multilayered data by correlating data representing each of the plurality of catchments in the rasterized data and data representing each of the plurality of catchments in the vectorized polygon data.

6. The computer-implemented method of claim 5, wherein correlating the data representing each of the plurality of catchments in the vectorized polygon data and the data representing each of the plurality of catchments in the rasterized data comprises automatically correlating:
the data representing each of the plurality of catchments within the geographical area represented by vectorized polygons in the vectorized polygon data; and
the data representing each of the plurality of catchments within the geographical area represented by rasterized data.

7. The computer-implemented method of claim 6, further comprising coordinating the multilayered data representing each of the plurality of catchments in the rasterized data and the data representing each of the plurality of catchments in the vectorized polygon data with geographic information system data visually representing the geographical area.

8. The computer-implemented method of claim 7, wherein the geographic information system data includes at least one of map data and satellite image data.

9. The computer-implemented method of claim 7, further comprising presenting to the user workstation a visualization of at least a portion of the geographical area, wherein the visualization is derived from the geographic information system data.

10. The computer-implemented method of claim 9, wherein the identification of the selected catchment from the plurality of catchments within a geographical area is made from the user workstation by a selection of the selected catchment from the visualization.

11. The computer-implemented method of claim 1, wherein the multilayered data includes data for each of the plurality of catchments indicating, for any particular catchment:
which of one or more catchments adjoining the particular catchment drains into the particular catchment;
a stream segment length within the particular catchment; and
an average velocity of water within the stream segment.

12. The computer-implemented method of claim 11, wherein automatically selecting from the multilayered data the group of navigated catchments that includes the one or more additional catchments within the group of navigated catchments that drain into the selected catchment includes:
for the selected catchment, identifying one or more upstream catchments from the one or more catchments adjoining the selected catchment that drain into the selected catchment; and
for each of the one or more or more upstream catchments, identifying all catchments that drain into each of the one or more upstream catchments.

13. The computer-implemented method of claim 12, wherein the multilayered data includes for each catchment in the group of navigated catchments, computing for each catchment in the group of navigated catchments:
a travel time to the selected catchment; and
a flow volume.

14. The computer-implemented method of claim 13, wherein the travel time for each catchment in the group of navigated catchments is determined relative to each adjoining catchment, and wherein the travel time to the selected catchment accounts for a time lag in flow of water from each catchment in the group of navigated catchments into each next catchment in the group of navigated catchments.

15. The computer-implemented method of claim 14, wherein the outflow from the selected catchment is determined as a sum of the flow volume from each of the catchments in the group of navigated catchments, wherein the flow volume from each of the catchments in the group of navigated catchments is applied to the outflow according to the travel time for the flow volume of each of the catchments to reach the selected catchment.

16. The computer-implemented method of claim 1, wherein the model presents the outflow of water from the selected location for each increment within the given time period.

17. The computer-implemented method of claim 1, further comprising graphically presenting the outflow of water in the model.

18. The computer-implemented method of claim 17, wherein graphically presenting the outflow of water in the model includes presenting at least one of:
a time series hydrograph;
a line graph; and
a bar chart.

19. The computer-implemented method of claim 1, further comprising receiving from the user workstation selection of the given time period.

20. The computer-implemented method of claim 1, further comprising:
receiving one or more inputs to alter parameters in at least one of the hydrological data, the geophysical data, and the meteorological data used in the generation of the model; and
regenerating the model based on the one or more inputs,
wherein effect of the one or more inputs to alter the parameters on the outflow of water from the selected catchment may be determined.

21. The computer-implemented method of claim 20, wherein the one or more inputs to alter the parameters in at least one of the hydrological data, the geophysical data, and the meteorological data used in the generation of the model include one or more of:
precipitation data;
temperature data;
land use data;
soil and other surface type data.

22. The computer-implemented method of claim 21, wherein the one or more inputs to alter the parameters are used in regenerating the model are separately stored within the database of multilayered data.

23. A non-transitory computer-readable storage medium storing instructions executable by a computer system to generate multilayered data usable in calculating: an outflow of water from a selected catchment the non-transitory computer-readable storage medium storing instructions to:
access a database of vectorized polygon data for each of a plurality of catchments within a geographical area;
access a database of rasterized data for the geographical area encompassing each of the plurality of catchments within the geographical area; and
generate multilayered data by correlating data for each of the plurality of catchments in the vectorized polygon data with the rasterized data corresponding to each of the plurality of catchments.

24. The non-transitory computer-readable storage medium of claim 23, wherein the vectorized polygon data includes one or more of
hydrological data;
soils and other surface type data; and
geophysical data.

25. The non-transitory computer-readable storage medium of claim 23, wherein the database of rasterized data includes one or more of meteorological data and land use data.

26. The non-transitory compute-readable storage medium of claim 23, further comprising coordinating the multilayered data with geographic information system data visually representing the geographical area.

27. The non-transitory computer-readable storage medium of claim 26, wherein the geographic information system data includes at least one of:
map data; and
satellite image data.

28. The non-transitory computer-readable storage medium of claim 30, wherein the multilayered data comprises data for each of the plurality of catchments including at least one of:
precipitation data;
temperature data; and
land use data.

29. A computer device having computer control code thereon, the computer control code configured to:
identify a selected catchment from a plurality of catchments within a geographical area;
receive, from a database, multilayered data for each of the plurality of catchments within the geographical area;
selecting a group of navigated catchments that drain into a selected catchment from the plurality of catchments within the geographical area; and
generating a model determining one of more characteristics of the catchment based on the selected group of navigated catchments and the multilayered database.
